(19) United States
(12) Patent Application Publication
(10) Pub. No.: US 2026/0085175 A1
(43) Pub. Date: Mar. 26, 2026

(54) MEMBRANE MATERIAL HAVING IMMISCIBLE POLYMERS FOR USE IN OPTICAL FIBER CABLE STRUCTURES

(71) Applicant: CORNING RESEARCH & DEVELOPMENT CORPORATION, Corning, NY (US)

(72) Inventor: Michael Alexander Heinz, Berlin (DE)

(21) Appl. No.: 19/408,822

(22) Filed: Dec. 4, 2025

Related U.S. Application Data
(63) Continuation of application No. PCT/US2024/030488, filed on May 22, 2024.
(60) Provisional application No. 63/471,850, filed on Jun. 8, 2023.

(51) Int. Cl. C08L 23/06; C08L 23/12; C08L 23/14; C08L 67/02; G02B 6/44

(52) U.S. Cl. CPC C08L 23/06; C08L 23/12; C08L 23/14; C08L 67/02; G02B 6/443; C08L 2203/30; C08L 2205/025; C08L 2205/03; C08L 2207/062

(57) ABSTRACT

Provided are embodiments of an extruded membrane material. The extruded membrane material includes a first thermoplastic polymer and a second thermoplastic polymer. The first thermoplastic polymer and the second thermoplastic polymer are immiscible. The first thermoplastic polymer forms a first phase oriented along an extrusion direction, and the second thermoplastic polymer forms a second phase oriented along the extrusion direction. The first phase is co-continuous with the second phase. Further, the extruded membrane material has a tensile yield strength of at least 10 MPa along the extrusion direction and a peel strength of 4 N or less transverse to the extrusion direction.

### CROSS-REFERENCE TO RELATED APPLICATION

This application is a continuation of Internation Patent Application No. PCT/US2024/030488, filed on May 22, 2024, which claims the benefit of priority of U.S. Provisional Application No. 63/471,850, filed on Jun. 8, 2023, the content of which is relied upon and incorporated herein by reference in its entirety.

### BACKGROUND OF THE DISCLOSURE

The present disclosure generally relates to optical fiber cables and in particular to a membrane material having enhanced peelability for use in optical fiber cables.

In general, an optical fiber cable needs to carry more optical fibers in order to transmit more optical data, and in order to carry more optical fibers, the size of the optical fiber cable conventionally needed to be increased. The increased size is at least partially the result of free space considerations to avoid macro- and micro-bending attenuation losses. For existing installations, size limitations and duct congestion limit the size of optical fiber cables that can be used without the requirement for significant retrofitting. Thus, it may be desirable to provide optical fiber cables having a higher fiber density (i.e., more fibers per cross-sectional area of the cable) without increasing the cable diameter such that the high fiber density cables can be used in existing ducts. Notwithstanding the desire for increased fiber density, organization and access to the optical fibers needs to be maintained. Conventional buffer tubes provide organization but are also thick and take up substantial space, decreasing fiber density and potentially making access difficult.

### SUMMARY OF THE DISCLOSURE

In a first aspect, embodiments of the present disclosure relate to an extruded membrane material. The extruded membrane material includes a first thermoplastic polymer and a second thermoplastic polymer. The first thermoplastic polymer and the second thermoplastic polymer are immiscible. The first thermoplastic polymer forms a first phase oriented along an extrusion direction, and the second thermoplastic polymer forms a second phase oriented along the extrusion direction. The first phase is co-continuous with the second phase. Further, the extruded membrane material has a tensile yield strength of at least 10 MPa along the extrusion direction and a peel strength of 4 N or less transverse to the extrusion direction.

In a second aspect, embodiments of the present disclosure relate to a lumen. The lumen includes a plurality of optical fibers and a membrane surrounding the plurality of optical fibers. The membrane is formed from the extruded membrane material as described in the first aspect. The membrane has a thickness of 100 μm or less.

In a third aspect, embodiments of the present disclosure relate to an optical fiber cable. The optical fiber cable includes a cable jacket having an inner surface and an outer surface. The inner surface defines a central bore extending along a longitudinal axis of the optical fiber cable, and the outer surface defines an outermost surface of the optical fiber cable. A plurality of lumens according to the second aspect are disposed within the central bore. The outer surface of the cable jacket defines a cross-sectional area perpendicular to the longitudinal axis, and the optical fiber cable has a fiber density of at least 7.5 fibers/mm² as measured at the cross-sectional area.

In a fourth aspect, embodiments of the disclosure relate to a method of forming a membrane material. In the method, a first thermoplastic polymer is blended with a second thermoplastic polymer. The first thermoplastic polymer is immiscible with the second thermoplastic polymer. Further, in the method, the first thermoplastic polymer and the second thermoplastic polymer are extruded together such that the first thermoplastic polymer forms a first phase oriented along an extrusion direction and the second thermoplastic polymer forms a second phase oriented along the extrusion direction. The first phase is co-continuous with the second phase. The membrane material has a tensile yield strength of at least 10 MPa along the extrusion direction and a peel strength of 4 N or less transverse to the extrusion direction.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments. In the drawings:

FIG. 1 depicts a cross-sectional view of a high fiber density optical fiber cable, according to exemplary embodiments;

FIG. 2 is a schematic depiction of a co-continuous phase morphology of a membrane material, according to exemplary embodiments;

FIG. 3 depicts a flow diagram of a method of forming a high fiber density optical fiber cable, according to exemplary embodiments;

FIG. 4 is a picture of a membrane peeled from around optical fibers in a lumen, according to an exemplary embodiment;

FIG. 5 is a graph of peel force over distance of peeling of a membrane of a lumen, according to an exemplary embodiment; and

FIG. 6 is a schematic depiction of an arrangement for measuring peel strength of the membrane material, according to an exemplary embodiment.

### DETAILED DESCRIPTION

Embodiments of the present disclosure relate to a membrane material configured to provide enhanced peelability for access to optical fiber cable structures. Optical fiber cables organize components into various structures using, for example, jackets, tubes, membranes, or binders. To access the components within those structures, often specialized tools are required, and accessing the structures can damage the components within. According to embodiments of the present disclosure, a membrane material is provided that includes a blend of immiscible polymers, which produces co-continuous polymer phases oriented along the direction of extrusion. These co-continuous phases define tear paths that allow for the membrane material to be torn and peeled by hand along its length, providing access to the components within the cable structure. In contrast to highly-filled polymers which have conventionally been used to provide peelable structures, the polymer blends do not need to contain any fillers and can be extruded at a consistent thickness across a wide range of thicknesses. As such, the membrane material can be used for a variety of cable structures to hold a variety of cable components. In exemplary embodiments discussed below, the membrane material is described in relation to a lumen containing a plurality of optical fibers in a high-density optical fiber cable. These and other aspects and advantages of the disclosed membrane material having enhanced peelability will be described in greater detail below and in relation to the accompanying figures. These exemplary embodiments are provided by way of illustration, and not by way of limitation.

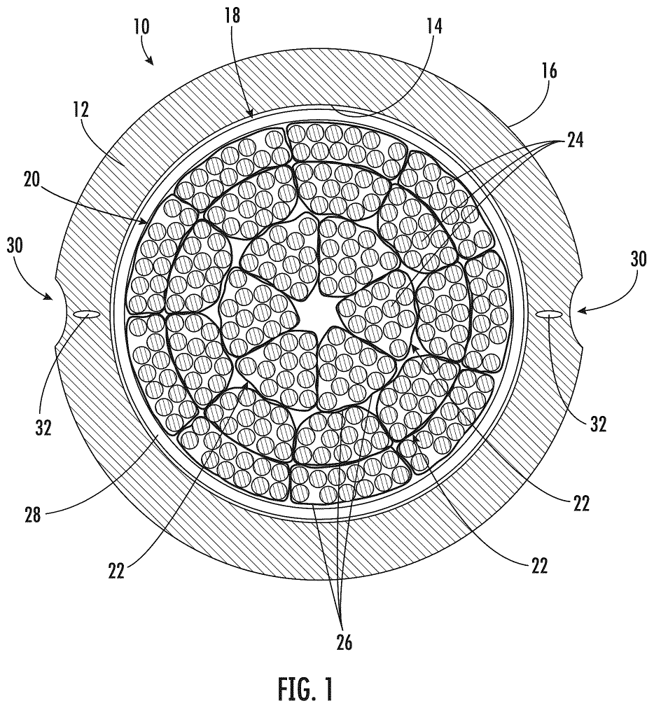

FIG. 1 depicts an example embodiment of a high fiber density optical fiber cable 10. The optical fiber cable 10 includes a cable jacket 12 having an inner surface 14 and an outer surface 16. The inner surface 14 of the optical fiber cable 10 defines a central bore 18 that extends along a longitudinal axis of the optical fiber cable 10. Disposed within the central bore 18 of the optical fiber cable 10 is cable core 20 including a plurality of subunits referred to herein as “lumens” 22. The lumens 22 each include a plurality of optical fibers 24 surrounded by a membrane 26. The membrane 26 is a thin and flexible sheath that allows for the lumen 22 to be reconfigured into a variety of different shapes. In this way, the lumens 22 can be densely packed within the cable core 20 by changing shape, e.g., flattening out, bunching up, or bending, as necessary to fill space within the cable core 20.

In one or more embodiments, the interior surface of the membrane 26 defines an interior cross-sectional area of the lumen 22. The portion of this interior cross-sectional area that is not occupied by the optical fibers 24 is referred to as “free space.” In one or more embodiments, each lumen 22 comprises a free space of 50% or less, 40% or less, 30% or less, or 25% or less. The low free space within the lumens 22 contributes to the high fiber density of the optical fiber cable 10. In one or more embodiments, the lumens 22 may also include a water-blocking material, such as a water-blocking gel, super-absorbent powders, or water-blocking yarn.

As discussed above, the lumens 22 may be stranded (such as SZ-stranded) in the cable core 20 in embodiments. The stranding enhances the ability to bend the cable while minimizing tensile and contractive forces within any of the fibers. During cable bending, the optical fibers 24 must be able to shift position, moving longitudinally to relieve those forces so as not to cause attenuation or break the optical fibers 24. Because the membranes 26 and cable core 20 do not provide free space for the optical fibers 24 to increase fiber density by design, the lumens 22 may be configured to move relative to each other in certain embodiments by using solid or gel lubricants, such as talc, or using water-absorbing powders.

Thus, in one or more embodiments, the optical fiber cable 10 may consist essentially of the cable jacket 12 surrounding a plurality of lumens 22. Other components that do not affect the basic and novel characteristics of the optical fiber cable 10 that may be included are, for example, a binder 28 provided between the plurality of lumens 22 and the cable jacket 12, water blocking material (e.g., tapes and powders), lubricants, friction-enhancing materials, and access features (e.g., ripcords or preferential tear features, such as a strip of dissimilar polymer in the cable jacket 12). In one or more embodiments, armor layers and strength elements are excluded from the construction of the optical fiber cable 10.

In one or more embodiments, the thickness of the membrane 26 is 100 μm or less, 90 μm or less, 80 μm or less, 70 μm or less, 60 μm or less, 50 μm or less, or 40 μm or less. In one or more embodiments, the thickness of the membrane 26 is 10 μm or more, 20 μm or more, 30 μm or more, or 35 μm or more. In one or more embodiments, the thickness of the membrane 26 is from 10 μm to 100 μm, in particular from 25 μm to 75 μm, and most particularly from 35 μm to 50 μm.

In one or more embodiments, the membrane 26 groups from two to one hundred forty-four in particular from eight to ninety-six, and particularly from twelve to twenty-four, optical fibers 24 into a lumen 22.

In one or more embodiments, the lumens 22 are surrounded by a binder 28. In one or more embodiments, the binder 28 is a thin film jacket having a thickness between 40 μm and 150 μm. In one or more embodiments, the binder 28 is provided to prevent sticking between the lumens 22 and the cable jacket 12, and thus, in one or more embodiments, the material of the binder 28 is selected to prevent sticking to both the lumens 22 and the cable jacket 12. Advantageously, using a thin binder 28 having a thickness in the disclosed thickness range reduces the thermal load of the binder 28 on the lumens 22 during extrusion of the binder 28.

In one or more embodiments, the cable jacket 12 has a thickness between the inner surface 14 and the outer surface 16 in a range from 0.5 mm to 1 mm. In particular embodiments, the cable jacket 12 has a thickness that is from 8% to 10% of the outer diameter of the optical fiber cable 10 (as measured at the outer surface 16 of the cable jacket 12). In one or more embodiments, the cable jacket 12 is made from a polyethylene material (such as high density polyethylene (HDPE)), a low-smoke zero halogen (LSZH) polymer, a filled polyethylene, a flame retardant (FR) polymer, or a urethane polymer, amongst other possibilities.

In one or more embodiments, the cable jacket 12 includes tactile locator features 30. In the embodiment depicted, the tactile locator features 30 comprise diametrically arranged depressions defined by the outer surface 16 of the cable jacket 12. However, in one or more other embodiments, the tactile locator features 30 comprise diametrically arranged bumps defined by the outer surface 16 of the cable jacket 12. The tactile locator features 30 assist a user in opening the cable 10 by guiding the user to the location of access features 32. In the embodiment of the optical fiber cable 10, the access features 32 are strips of dissimilar polymer embedded in the polymer of the cable jacket 12. For example, the cable jacket 12 may substantially comprise polyethylene, and the dissimilar polymer of the access feature 32 may be polypropylene. The immiscibility of polyethylene cable jacket 12 and the polypropylene access features 32 prevents a strong bond from forming between the cable jacket 12 and the access features 32, allowing for a user to tear through the cable jacket 12 in the region of the access features 32. Further, once opened at the access features 32, the cable jacket 12 can be split along its length along the access features 32.

In one or more embodiments, the optical fiber cable 10 includes from 48 to 864 optical fibers 24, or from 96 to 576 optical fibers 24, or from 144 to 288 optical fibers 24. In one or more embodiments, the optical fiber cable 10 has a fiber density of at least 7.5 fibers/mm². The fiber density is measured based on the number of optical fibers 24 per cross-sectional area of the optical fiber cable 10 as measured from the outer surface 16. In one or more embodiments, the fiber density is at least 8 fibers/mm², at least 8.5 fibers/mm², at least 9 fibers/mm², at least 9.5 fibers/mm², at least 10 fibers/mm², at least 10.5 fibers/mm², at least 11 fibers/mm², at least 11.5 fibers/mm², or at least 12 fibers/mm². In one or more embodiments, the fiber density may be up to 17 fibers/mm². Further, in one or more embodiments, the outer diameter of the optical fiber cable 10 as measured at the outer surface 16 is 9 mm or less, 8.5 mm or less, 8 mm or less, 7.5 mm or less, 7 mm or less, 6.75 mm or less, 6.5 mm or less, 6.25 mm or less, 6 mm or less, 5.75 mm or less, 5.5 mm or less, 5.25 mm or less, or 5 mm or less. Further, in one or more embodiments, the outer diameter of the optical fiber cable 10 as measured from the outer surface 16 is at least 2 mm.

In one or more embodiments, the optical fiber cable 10 has a cumulative fiber filling coefficient of at least 50%, at least 60%, at least 65%, or at least 70%. In one or more embodiments, the optical fiber cable 10 has a cumulative fiber filling coefficient of up to 85%. As used herein, the term “cumulative fiber filling coefficient” of an optical-fiber cable 10 refers to the ratio of the sum of the cross-sectional areas of all of the optical fibers 24 within the optical-fiber cable 10 versus the inner cross-sectional area of the optical-fiber cable 10 (i.e., defined by the inner surface 14 of the cable jacket 12 or inner surface of binder 28, if included). The cross-sectional area of each optical fiber 24 is determined based on an outer surface of the optical fiber 24.

In one or more embodiments, the optical fiber cable 10 comprises a free space of at most 50%, at most 42.5%, at most 30%, or at most 25%. In one or more embodiments, the free space of the optical fiber cable 10 is at least 15%. As used herein, the free space is the inverse of cumulative fiber filling coefficient (i.e., 100%-cumulative fiber filling coefficient).

According to embodiments of the present disclosure, the lumens 22 comprise a membrane 26 formed from a membrane material that is configured to be finger-peelable without damaging the optical fibers 24 within the lumen 22. This property relates to the ability of an installer to access the optical fibers 24 within the lumen 22 without the need for specialized equipment and without damaging the optical fibers 24. While the thickness of the membrane 26 is an important factor affecting the peelability of the lumen 22, the inventors have determined that providing a membrane 26 with a desired thickness alone is not sufficient to provide consistent peelability without damaging the optical fibers 24. As mentioned above, the membrane material is described in relation to the membrane 26 of a lumen, but the membrane material can also be used for other structures, such as, for example, the binder 28. In other cable constructions, the membrane material may be used for other structures, such as various tube or jacket structures.

Certain efforts to improve peelability have focused on forming the membrane 26 from a highly-filled polymer composition, such as compositions having from 25 wt % to 60 wt % of a filler component. However, such highly-filled polymer compositions are difficult to process at the desired low thickness of the membrane. One reason for the inability to process the membrane to the desired thickness is the agglomeration of particles in the filler component. It has been found that agglomerations of about 10× the size of the particle are easily formed in the filler component. Further, being highly-filled, the polymer composition tends to have large agglomerations positioned in close proximity, which makes processing the membrane at the desired thicknesses difficult. Further, the highly-filled compositions have purposely degraded mechanical properties (to provide peelability) that can lead to tearing of the membrane when integrating the subunits into the cable core.

According to embodiments of the present disclosure, the polymer composition of the membrane 26 contains a blend of immiscible thermoplastic polymers that create co-continuous polymer phases. Advantageously, the co-continuous phases control the tear resistance of the thin membranes, making tearing along the extrusion direction easier because of the comparatively weak transverse connections between the phases. Further, the blend of immiscible polymers can be extruded at consistent thicknesses in the range of 25 μm to 250 μm, for example. That is, the membrane can be extruded at any desired thickness within the range while also providing controlled mechanical properties to achieve peelability. As the polymers melt and are blended together, the polymer phases mix and create co-continuous structures which act as tear propagation paths. Further, extrusion processing leads to phase orientation in the extrusion direction such that the phases are elongated, facilitating peeling of the membrane apart along its length. However, the membrane has sufficient tensile strength and bending performance for various stranding and assembly processes, especially as compared to highly-filled compositions.

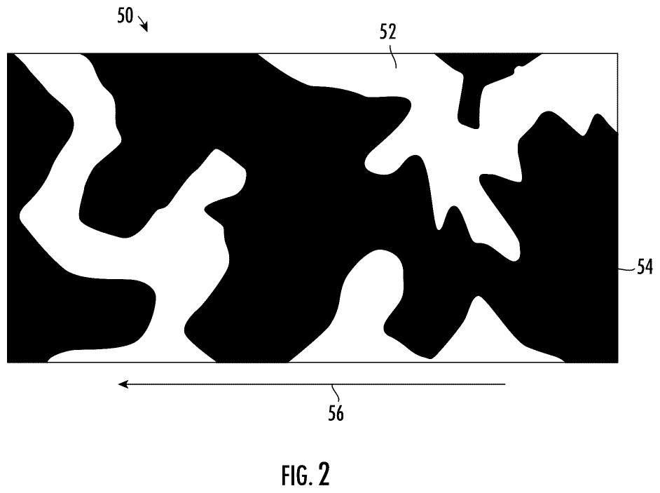

FIG. 2 schematically depicts an example of the co-continuous phase morphology of the membrane material 50. In particular, the membrane material 50 includes a first phase 52 of a first thermoplastic polymer and a second phase 54 of a second thermoplastic polymer. As can be seen, the phases 52, 54 are generally oriented in direction 56, which is the direction that the membrane material is extruded. While two phases 52, 54 are depicted, the co-continuous phase morphology 50 may include additional phases of other thermoplastic polymers included in the blend.

In one or more embodiments, the membrane material 50 comprises a blend of at least two immiscible thermoplastic polymers. The thermoplastic polymers are not particularly limited in terms of molecular weight and distributions, and the thermoplastic polymers may be homopolymers, heteropolymers, or copolymers. In general, the thermoplastic polymers are selected from among polyolefins, polyvinylchloride, polystyrene, acrylonitrile butadiene styrene, styrene-acrylonitrile, styrene-ethylene-butylene-styrene, and technical thermoplastics. In one or more embodiments, the polyolefins include polyethylenes (very low density, linear low density, low density, medium density, high density, and ultrahigh molecular weight), polypropylene (isotactic, syndiotactic, and atactic), and polyolefin-based thermoplastic elastomers (such as ethylene vinyl acetate, ethylene butyl acrylate, ethylene methyl acrylate, thermoplastic olefin elastomer, ethylene-propylene rubber, and ethylene propylene diene monomer rubber). In one or more embodiments, the technical thermoplastics include polyesters (such as polybutylene terephthalate, polyethylene terephthalate, polycarbonate, poly methyl methacrylate, and polyoxymethylene), polyethers (such as polyphenylene ether and poly(p-phenylene oxide)), polyamides (such as polyamide 6, polyamide 12, polyamide 6.6, polyamide 4.6, and polyamide 11), polyacetal, polysulfones (such as polyethersulfone, polysulfone, and polyphenylene sulfide), polyimides, and polyketones.

In one or more embodiments, the membrane material comprises a blend of two polyolefins, such as a blend of polyethylene and polypropylene. In such embodiments, each polyolefin may be present in an amount of, 5 wt % to 95 wt %, in particular, 7.5 wt % to 92.5 wt %, more particularly, 10 wt % to 90 wt %, still more particularly 15 wt % to 85 wt %. In some embodiments, each polyolefin may be present in an amount of 30 wt % to 70 wt %. In one or more embodiments, the blend may comprise a third immiscible polymer, in particular a technical thermoplastic. In one or more such embodiments, the technical thermoplastic may be present in an amount of 2 wt % to 10 wt %.

In one or more embodiments, the membrane material comprises a blend of a polyolefin and a technical thermoplastic, such as a polyethylene or polypropylene and a polyester. In such embodiments, the polyolefin may be present in an amount of 25 wt % to 85 wt %, and the technical thermoplastic may be present in an amount of 15 wt % to 75 wt %.

In one or more embodiments, the membrane material may further include a coupling agent. In one or more embodiments, the coupling agent is one of the polymers in the blend functionalized with a functional group. In one or more embodiments, the functional group is maleic anhydride, silane, epoxy, acrylate, amine, hydroxyl, melamine, zirconate, titanate, polyol, or ester. In one or more embodiments, the coupling agent is present in an amount of up to 50 wt %. It is believed that the coupling agent increases the polarity of one polymer phase of the membrane material, providing a finer phase morphology, which improves surface quality and repeatability and stability of the peeling performance.

In one or more embodiments, the membrane material includes less than 10% of fillers. In one or more embodiments, the membrane material does not include any fillers besides colorants. Advantageously, the lack of fillers allows for stable and high speed processing. With respect to colorants, Applicant has found that the membrane material is relatively easy to provide with opaque color. In particular, the immiscibility of the polymers produce phases that scatter light. Thus, with the addition of small amounts of colorant, the membrane material can be provided with vivid color. In one or more embodiments, the colorant can be added through a color batch. In one or more embodiments, the membrane material includes color batch in an amount in a range from 1 wt % to 5 wt %, in particular about 3 wt %. It is to be appreciated, however, that a greater amount of a colorant may be used. Certain conventional polymers consisting of a single phase do not take color well and remain translucent such that internal components can be seen even with the addition of large amounts of colorants.

It is to be understood that in embodiments described herein in which the membrane material includes one or more additives such as a third immiscible polymer, a coupling agent, a filler, a colorant, or the like, a disclosed wt % value of one of the first immiscible polymer or the second immiscible polymer may be reduced by a necessary amount to account for a wt % of the additive. For example, in an embodiment wherein the first immiscible polymer is present in an amount of 5 wt % to 95 wt % and the third immiscible polymer is present in an amount of 2 wt % to 10 wt %, the second immiscible polymer may be present in an amount of 5 wt % to 93 wt % to account for the necessary minimum amount of the third immiscible polymer. Such modifications are considered to be consistent with and part of the present disclosure, although every possible such combination is not specifically enumerated for the sake of brevity.

In one or more embodiments, the membrane material has a tensile yield strength measured according to ISO 527 of at least 10 MPa, at least 15 MPa, or at least 20 MPa. In one or more embodiments, the membrane material has a tensile yield strength of up to 50 MPa. The tensile yield strength of the membrane material is measured along the direction of extrusion (e.g., direction 56 of FIG. 2, which is generally along the elongated co-continuous phases 52, 54). In one or more embodiments, the membrane material has a yield strength in a direction transverse to the extrusion direction that is less than the yield strength along the extrusion direction. In one or more embodiments, the transverse yield strength is at least 50% less, at least 60% less, at least 70% less, at least 80% less, or at least 90% less than the yield strength along the extrusion direction. In one or more embodiments, the average peel strength as measured transverse to the extrusion direction is 4 N or less, 3 N or less, 2 N or less, 1.5 N or less, or 1 N or less. In one or more embodiments, the average peel strength is in a range from 0.25 N to 4 N. The measurement of peel strength will be discussed more fully below in relation to the experimental examples. In a sense, the peel strength is measured similarly to but modified from the determination of tear strength according to ISO

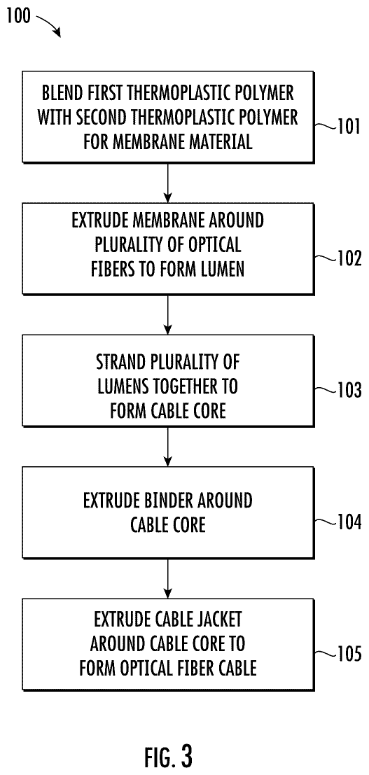

Having described the optical fiber cable 10 and embodiments of a polymer composition for forming the membrane 26, embodiments of a method 100 for manufacturing an optical fiber cable 10 including a plurality of lumens 22 will be described in relation to the flow diagram of FIG. 3. In one or more embodiments, the method 100 involves blending at least a first thermoplastic polymer with a second thermoplastic polymer in a first step 101. Advantageously, blending may be performed by just dry blending pellets of the first thermoplastic polymer with pellets of the second thermoplastic polymer. That is, no further compounding steps are required to blend the immiscible polymers. Further, in one or more embodiments, the blending (including dry blending) may involve three or more thermoplastic polymers. In a second step 102, the membrane 26 is extruded around the plurality of optical fibers 24.

In one or more embodiments, for a twelve-fiber lumen 22, the membrane 26 may be extruded around the optical fibers 24 while the optical fibers 24 are in a 3×4 rectangular or offset rectangular arrangement or a 2×6 rectangular or parallelogram arrangement. In these initial configurations, the lumens 22 may be able to more easily shift to the various space-saving configurations, such as those shown in FIG. 1, to provide a high fiber density optical fiber cable 10. In other exemplary initial configurations, the optical fibers 24 of a lumen 22 may be in a 3+9 arrangement (i.e., having 3 of the fibers 24 aligned in a first row, and 9 of the fibers 24 aligned in a second row) when the membrane 26 is extruded.

In one or more embodiments of the method 100, the lumens 22 are formed into a cable core 20 in a third step 103. In embodiments, the lumens 22 extend straight along the longitudinal axis of the optical fiber cable 10 in the cable core 20, and in other embodiments, the lumens 22 are stranded (e.g., S-stranded, Z-stranded, or SZ-stranded) along the longitudinal axis in the cable core 20.

In one or more embodiments of the method 100, the binder 28 is optionally extruded around a plurality of lumens 22 in a fourth step 104. In a fifth step 105 of the method 100, a cable jacket 12 is then extruded around the lumens 22 or binder 28, as the case may be. During extrusion of the cable jacket 12, the access feature 32 and the tactile locator features 30 may be formed in the cable jacket 12 through the use of specially-configured extrusion die-heads. A vacuum may be pulled during extrusion of the cable jacket 12, which squeezes the cable jacket 12 down around the lumens 22. Additionally or alternatively, the cable jacket 12 can be made thicker, which results in greater shrinkage during cooling, compressing the lumens 22. Advantageously, by compressing the cable jacket 12 around the lumens 22, the individual lumens 22 may be manufactured with a higher than desired free space, and the force of the cable jacket 12 on the lumens 22 in the cable core 20 can reconfigure the lumens 22 into shapes with lower free space within the optical fiber cable 10.

### EXPERIMENTAL EXAMPLES

### Example 1

Blends of immiscible polymers were prepared and extruded to form lumens. In the blends, polybutylene terephthalate (PBT) was mixed with each of high-density polyethylene (HDPE), linear low-density polyethylene (LLDPE), low-density polyethylene (LDPE), and polypropylene (PP). The PBT was mixed with each of the other polymers at 75/25 to 25/75 weight percent. Advantageously, each blend was able to be prepared through dry-blending pellets of each polymer and feeding the resulting blend into a single screw extruder. The blends were extruded at high extrusion speeds at thicknesses of 20 μm to 50 μm.

### Example 2

The peelability effects were investigated for the blends of Example 1. In the trials, a lumen was cut to a target length, and a crack was initiated at an end of the lumen by either pulling at the end with a fingernail or rolling the end between fingertips. Each lumen was separated from the optical fibers contained therein by (1) using the optical fibers as a ripcord and pulling the lumen and optical fibers away from each other, (2) pulling a portion of the optical fibers away from another portion of the optical fibers to tear through the lumen, or (3) holding the optical fibers and one side of the lumen in one hand and pulling the other side of the lumen with the other hand. Each of the methods was successful at removing the lumen from the optical fibers, and the lumen tore in one or more strings of membrane material. Each lumen was able to be torn to a target length without damaging the optical fibers, and then the lumen material was cut off.

Applicant found that mixtures of PBT and the other polymers at a weight percent of 40% to 60% were particularly effective for peelability. FIG. 4 depicts the strings of the membrane 26 stripped from around optical fibers 24 of the lumen 22. The membrane material of the lumen 22 was formed of a 50/50 weight percent mixture of PBT and HDPE.

### Example 3

For comparison, peelability of lumens formed from pure PBT and HDPE membranes was investigated. Attempts were made to peel the membranes of the lumens as described in Example 2. However, Applicant was unable to open or crack the ends of lumens by hand, and pulling on the fibers like a ripcord caused the membrane to clinch. The pure PBT and HDPE membranes only included a single polymer phase instead of co-continuous phases that provide tear paths for peeling. Further, despite the thinness of the membrane, the membrane was not easily torn.

### Example 4

Lumens formed from membranes of the blends of polymers described in Example 1 were wrapped several times around a 10 mm mandrel. The lumens were analyzed for cracks or tears, and none were observed. The mandrel test is indicative of the ability of the lumen to withstand various processes during cable manufacturing, such as stranding of the lumens within the cable core. Previous, highly-filled thin membranes not only were difficult to process uniformly but also tended to tear during cable processing. In contrast, the presently disclosed membrane material was able to be wrapped several times around a mandrel and even folded without cracking. Additionally, the lumens formed of the disclosed membrane material and wrapped around the mandrel were exposed to temperature cycling from −40° C. to 90° C. and back without failure. Thus, the presently disclosed membrane materials provide peelability, processability, and temperature stability.

### Example 5

Tensile properties of blends of polymers as shown in Table 1, below, were prepared and tested for yield strength and elongation at break according to ISO 527. The blends included PBT and HDPE as the base polymers. Two blends further included a coupling agent (maleic anhydride grafted polyethylene (MA-g-PE)), and two blends further included a color master batch.

TABLE 1
Membrane Material Sample Compositions and Tensile Properties

| | | Yield | Elongation |
|---|---|---|---|
| | | Strength | at Break |
| Sample | Composition | (MPa) | (%) |
| 1 | 50 wt % PBT | 21.2 | >300 |
| | 50 wt % HDPE | | |
| 2 | 60 wt % PBT | 21.5 | >300 |
| | 40 wt % HDPE | | |
| 3 | 50 wt % PBT | 20.4 | >300 |
| | 40 wt % HDPE | | |
| | 10 wt % MA-g-PE | | |
| 4 | 50 wt % PBT | 21.1 | >300 |
| | 47 wt % HDPE | | |
| | 3 wt % Colorbatch | | |
| 5 | 50 wt % PBT | 23.0 | >300 |
| | 37 wt % HDPE | | |
| | 10 wt % MA-g-PE | | |
| | 3 wt % Colorbatch | | |

The tensile testing was performed in the extrusion direction. As can be seen, the yield strength was substantially consistent across the samples and was at least 20 MPa. Additionally, all of the samples exhibited an elongation at break of greater than 300%, and some samples achieved an elongation at break of greater than 600%.

An attempt was made to determine the tensile strength transverse to the extrusion direction, but the samples could not be properly gripped. Thus, the transverse strength was measured by determining the force required to peel the membrane material part.

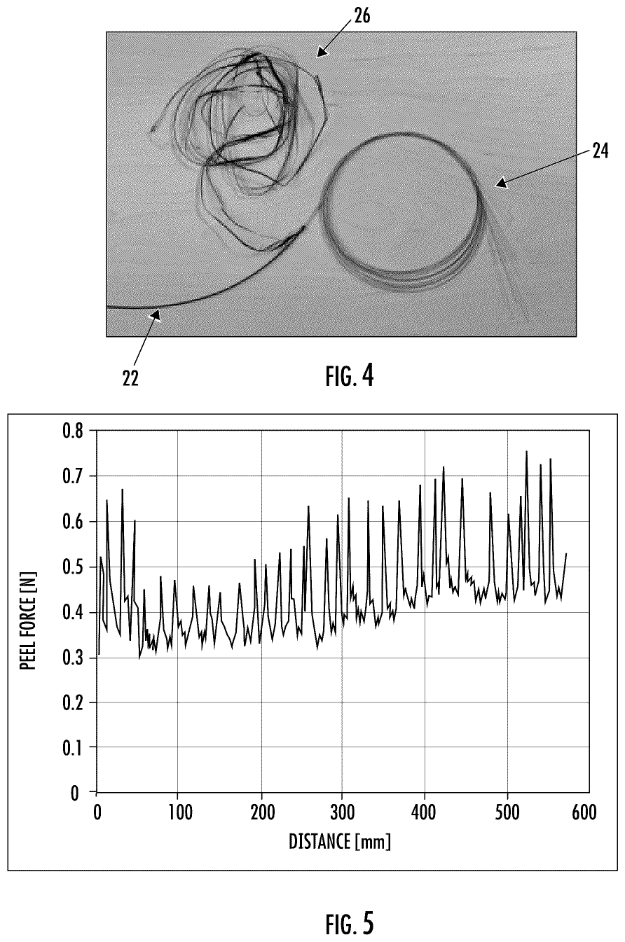

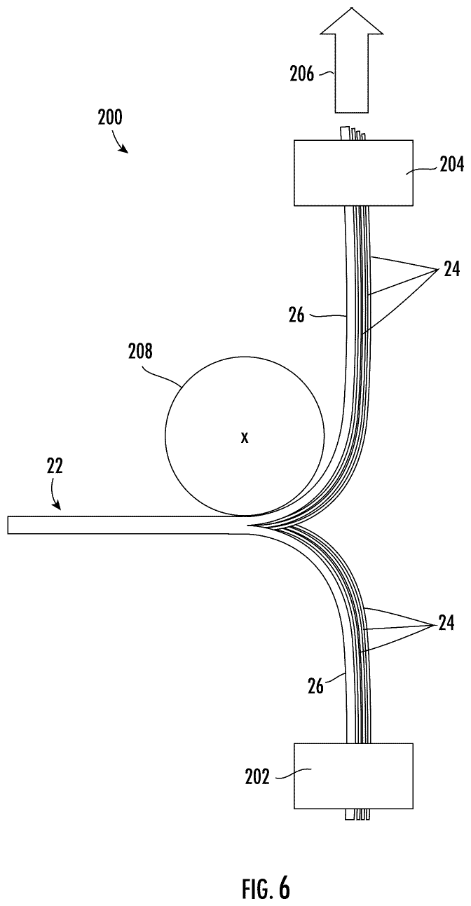

FIG. 5 depicts a graph of the peel force as a function of peeling distance. As can be seen, the peel force was less than 2 N, in particular less than 1 N, for over 500 mm of peeling. A peel strength of 2N or less is associated with ease of peelability for accessing of optical fiber subunits.

FIG. 6 depicts the experimental arrangement 200 for determining peel strength of the membrane material as incorporated into a subunit. For the testing, a 12-fiber subunit (lumen 22) was opened at one end and split longitudinally such that the membrane 26 was divided in half. Six optical fibers 24 were provided with each half of the membrane 26. One half of the membrane 26 and six optical fibers 24 were fixed in a lower clamp 202, and the other half of the membrane 26 and the remaining six optical fibers 24 were fixed in an upper clamp 204. The upper clamp 204 was moved in direction 206 at a speed of 50 mm/min while the lower clamp 202 remained stationary. The force required to move the upper clamp 204 was measured using a sensor proximal to the upper clamp 204. To ensure that each half of the membrane 26 was being pulled in a 90° orientation to the subunit 12, a guide wheel 208 was provided adjacent to the peeling location. For the reported peel strength measurement, the first 10% of the pulling distance and the last 10% of the pulling distance were cutoff, and the average and standard deviation of the curve was measured.

### Example 6

Additional samples were prepared and determined to be effective as a membrane material for lumens. The compositions are disclosed in Table 2 below.

TABLE 2
Additional Samples of Membrane Materials

| | | | PP | PP |
|---|---|---|---|---|
| Sample | PBT | HDPE | homopolymer | heteropolymer |
| 6 | 75% | 25% | — | — |
| 7 | 50% | 50% | — | — |
| 8 | 15% | 85% | — | — |
| 9 | 30% | — | 70% | — |
| 10 | 25% | — | 75% | — |
| 11 | 22.5% | — | — | 77.5% |
| 12 | 15% | — | — | 85% |
| 13 | — | 70% | 30% | — |
| 14 | — | 50% | — | 50% |
| 15 | — | 30% | — | 70% |
| 16 | 5% | 47.5% | — | 47.5% |
| 17 | 2.5% | 47.5% | — | 50% |

From Table 2, it can be seen that the compositions of the membrane material comprise various binary or tertiary blends of PBT, HDPE, PP homopolymer, and/or PP heteropolymer. Samples 6-8 were binary blends of PBT/HDPE in 75/25, 50/50, and 15/85 weight percents. Samples 9-12 were binary blends of PBT/PP in which the blends were majority PP. Samples 9 and 10 used PP homopolymer with PBT/PP in 30/70 and 25/75 weight percents. Samples 11 and 12 used PP heteropolymer with PBT/PP in 22.5/77.5 and 15/85 weight percents. Samples 13-15 were binary blends of HDPE/PP. Sample 13 used PP homopolymer with HDPE/PP in 70/30 weight percents, and Samples 14 and 15 used PP heteropolymer with HDPE/PP in 50/50 and 30/70 weight percents. Samples 16 and 17 were tertiary blends of PBT/HDPE/PP with the PP being a heteropolymer. Sample 16 included PBT/HDPE/PP in 5/47.5/47.5 weight percents, and Sample 17 included PBT/HDPE/PP in 2.5/47.5/50 weight percents.

Each of these compositions exhibited good peelability and processability and a smooth surface roughness.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A subunit, comprising:
a plurality of optical fibers; and
a membrane surrounding the plurality of optical fibers, the membrane formed of an extruded material comprising:
a first thermoplastic polymer; and
a second thermoplastic polymer;
wherein the first thermoplastic polymer and the second thermoplastic polymer are immiscible;
wherein the first thermoplastic polymer forms a first phase oriented along an extrusion direction and the second thermoplastic polymer forms a second phase oriented along the extrusion direction, the first phase being co-continuous with the second phase;
wherein the extruded membrane material comprises a tensile yield strength of at least 10 MPa along the extrusion direction and a peel strength of 4 N or less transverse to the extrusion direction.

2. The subunit of claim 1, wherein the first thermoplastic polymer is a polyolefin.

3. The subunit of claim 2, wherein the polyolefin is selected from a group consisting of polyethylene, a polypropylene, a polyolefin-based elastomer, and combinations thereof.

4. The subunit of claim 2, wherein the polyolefin is a polyethylene or a polypropylene.

5. The subunit of claim 4, wherein the second thermoplastic polymer is a technical thermoplastic.

6. The subunit of claim 5, wherein the technical thermoplastic is selected from a group consisting of a polyester, a polyether, a polyamide, a polyacetal, a polysulfone, a polyimide, a polyketone, and combinations thereof.

7. The subunit of claim 5, wherein the extruded material comprises from 25 wt % to 85 wt % of the polyolefin and from 15 wt % to 75 wt % of the technical thermoplastic.

8. The subunit of claim 1, wherein the first thermoplastic polymer and the second thermoplastic polymer are selected from a group consisting of a polyolefin, a polyvinylchloride, a polystyrene, an acrylonitrile butadiene styrene, a styrene-acrylonitrile, a styrene-ethylene-butylene-styrene, and combinations thereof.

9. The subunit of claim 1, wherein the extruded material further comprises a third thermoplastic polymer.

10. The subunit of claim 9, wherein the third thermoplastic polymer comprises a technical thermoplastic.

11. The subunit of claim 10, comprising from 5 wt % to 95 wt % of the first thermoplastic polymer, from 5 wt % to 93 wt % of the second thermoplastic polymer, and from 2 wt % to 10 wt % of the technical thermoplastic.

12. The subunit of claim 1, wherein the membrane has a thickness of 100 μm or less.

13. An optical fiber cable, comprising:
a cable jacket comprising an inner surface and an outer surface, the inner surface defining a central bore extending along a longitudinal axis of the optical fiber cable and the outer surface defining an outermost surface of the optical fiber cable;
a plurality of subunits according to claim 1 disposed within the central bore;
wherein the outer surface of the cable jacket defines a cross-sectional area perpendicular to the longitudinal axis and wherein the optical fiber cable comprises a fiber density of at least 7.5 fibers/mm² as measured at the cross-sectional area.

14. A method of forming an optical fiber subunit, comprising:
blending a first thermoplastic polymer with a second thermoplastic polymer, the first thermoplastic polymer being immiscible with the second thermoplastic polymer;
extruding the first thermoplastic polymer and the second thermoplastic polymer together to form a membrane that surrounds a plurality of optical fibers, wherein the first thermoplastic polymer forms a first phase oriented along an extrusion direction and the second thermoplastic polymer forms a second phase oriented along the extrusion direction, the first phase being co-continuous with the second phase;
wherein the membrane has a tensile yield strength of at least 10 MPa along the extrusion direction and a peel strength of 4 N or less transverse to the extrusion direction.

15. The method of claim 14, wherein blending further comprises blending the first thermoplastic polymer and the second thermoplastic polymer with a coupling agent.

16. The method of claim 15, wherein the coupling agent comprises either the first thermoplastic polymer or the second thermoplastic polymer functionalized with a functional group selected from a group consisting of maleic anhydride, silane, epoxy, acrylate, amine, hydroxyl, melamine, zirconate, titanate, polyol, or ester.

17. The method of claim 15, wherein the membrane material comprises up to 15 wt % of the coupling agent.

18. The method of claim 15, wherein the first thermoplastic polymer is a first polyolefin.

19. The method of claim 18, wherein the second thermoplastic polymer is a technical thermoplastic.

20. The method of claim 18, wherein the second thermoplastic polymer is a second polyolefin different from the first polyolefin.
